(19) United States
(12) Patent Application Publication
(10) Pub. No.: US 2015/0039413 A1
(43) Pub. Date: Feb. 5, 2015

(54) METHOD AND SYSTEM FOR MAKING PAYMENTS AND RECEIVING REBATES

(71) Applicants: EYAL MESIKA, (US); YEHUDA MESIKA, (US)

(72) Inventor: Yair Winkler, Ceasaria (IL)

(73) Assignees: Eyal MESIKA, Holon (IL); Yehuda MESIKA, Holon (IL)

(21) Appl. No.: 14/380,075

(22) PCT Filed: Feb. 24, 2013
(86) PCT No.: PCT/IL13/00022

§ 371 Date: Aug. 21, 2014

Related U.S. Application Data
(60) Provisional application No. 61/602,166, filed on Feb. 23, 2012.

(51) Int. Cl. G06Q 30/02; G06F 17/30

(52) U.S. Cl. CPC G06Q 30/0234; G06F 17/30864
USPC 705/14.34

(57) ABSTRACT

A method and system for providing a rebate for a purchase, the method including collecting, in a database of a rebate server, personal data and transaction history regarding a personal subscriber, receiving rebate parameters from a business subscriber in a database of the rebate server, calculating a personal rebate for a new transaction based on the subscriber data and the rebate parameters for the subscriber and, upon receipt of payment for the new transaction, providing the personal rebate to the subscriber.

### FIELD OF THE INVENTION

The present invention relates to a rebate system in general and, in particular, to a method and system for making payments and receiving a rebate.

### BACKGROUND OF THE INVENTION

There are known many systems for making payments and receiving rebates. Typically, the customer will have to pay using a specific credit card in order to receive the rebate. Thus, these systems are limited as to which means may be used by a customer when he or she is making the payment for the desired transaction. Alternatively, a sales slip must be mailed to the seller in order for the customer to receive the rebate.

Furthermore, rebate and discount systems have a standard rebate or discount for all customers. These standard rebates may be provided for selected articles customized for the particular customer, calculated according to frequently purchased items. Friends may be informed of purchases by word of mouth or by sharing on social networks. Finally, these standard rebates that are offered are generally pre-set by the business for presentation to all of a group of customers.

Therefore, there is a long felt need for a method and system for receiving rebates for payments made by any means and it would be desirable if the system provided a personalized rebate for each customer.

### SUMMARY OF THE INVENTION

The present invention relates to a rebate system which provides a personalized rebate in real time for each customer, according to a personal grade or score. These rebates are provided to customers who pay by any method, including cash, credit card or even payment by a third party for that customer. The system includes software that calculates a personalized rebate for each purchase of each customer, which may be according to his or her purchasing history, either in that shop or in general, and/or based on data regarding his or her social network connections. These rebates are calculated in real time based on the customer's personal information and rebate parameters of the business for a specific marketing campaign, such as a targeted demographic or other data provided by the business offering the rebate. This rebate may be utilized at the point of sale or may accrue in a customer account for later purchases by the customer.

According to some embodiments, a second, larger, rebate may be offered if the customer agrees, on the spot, to indicate to his or her social network that the purchase is being made and/or to provide positive comments about the vendor. Thus, the system of the present invention, unlike conventional systems, offers the customer real time personalized rebates which are tailored according to the status of the customer and/or to actions that may be performed by him or her.

According to the present invention, there is provided a method of payment for a transaction including the steps of receiving rebate parameters from a business, collecting data pertaining to a subscriber, calculating a regular personal rebate for the subscriber for a particular transaction within the rebate parameters, and, upon receipt of payment for the transaction, providing the regular personal rebate to the subscriber.

According to some embodiments, the method further includes calculating a higher, personal posting rebate for the subscriber for the transaction for posting information of the transaction on a social network and, upon receipt of payment for the transaction, providing one of the regular personal rebate or the personal posting rebate to the subscriber.

According to some embodiments of the invention, the receipt of payment includes receipt of payment by any one of the group including cash, a subscriber's credit card, a third party's credit card, a coupon or system credit.

In accordance with the invention, there is also provided a system for making payments and receiving rebates, the system including a rebate server coupled to at least one social media website through the Internet, a system database coupled to the rebate server, an electronic cashier of at least one business coupled for two way communication to the rebate server, a processing device of at least one subscriber coupled for two way communication to the rebate server and coupled to said at least one social media website through the Internet, and a processor in said rebate server configured to collect data about the at least one subscriber, compare it with rebate parameters received from the at least one business and calculate, in real time, a personal rebate for a transaction by the subscriber at the business and provide the personalized rebate to the subscriber and to the business.

### BRIEF DESCRIPTION OF THE DRAWINGS

The present invention will be further understood and appreciated from the following detailed description taken in conjunction with the drawings in which:

FIG. 1 is a block diagram of a rebate system according to one embodiment of the invention.

FIG. 2 is a flow chart of the method for providing a rebate according to one embodiment of the invention.

FIGS. 3-12 are exemplary screen views showing operation of the rebate system, in accordance with one embodiment of the present invention.

In particular:

FIG. 3 is an exemplary screen view illustrating personalized discount prices displayed on the subscriber's mobile device of a rebate system application for a mobile device.

FIG. 4 is an exemplary screen view illustrating available desired methods of payment displayed on the subscriber's mobile device of a rebate system application for a mobile device.

FIG. 5 is an exemplary screen view illustrating selecting a personalized discount price displayed on the subscriber's mobile device of a rebate system application for a mobile device.

FIG. 6 is an exemplary screen view illustrating the subscriber's social network wall displayed on the subscriber's mobile device of a rebate system application for a mobile device.

FIG. 7 is an exemplary screen view illustrating a token when paying with credit or cash displayed on the business's mobile device of a rebate system application for a mobile device or POS terminal.

FIG. 8 is an exemplary screen view illustrating a token when paying with accrued system credit displayed on the business's mobile device or POS terminal of a rebate system application for a mobile device or POS terminal.

FIGS. 9 and 10 are exemplary screen views illustrating inserting the amount of the transaction displayed on the business's mobile device or POS terminal of a rebate system application for a mobile device or POS terminal.

FIG. 11 is an exemplary screen view illustrating a confirmation screen displayed on the business's mobile device or POS of a rebate system application for a mobile device or POS terminal.

FIG. 12 is an exemplary screen view illustrating a receipt displayed on the subscriber's mobile device of a rebate system application for a mobile device.

### DETAILED DESCRIPTION OF THE INVENTION

The present invention relates to a system and method of payment providing immediate and personalized monetary rebates (hereinafter: “personal rebates”) to individual subscribers for selected transactions. These rebates are obtained by making payments by any payment means at a business' cashier, payment terminal or website. These rebates are provided for payments made, for example, by using the subscriber's credit card, a third party's credit card, cash or any other payment method. Each personal rebate is generated in real time and personalized according to a personal grade or score calculated based on at least one, and preferably several, pieces of personal information or data pertaining to the subscriber. This piece of personal data can be a social connection statistic (e.g., how many friends, or followers a subscriber has), financial information (e.g., their previous purchases), or a geographical location (e.g., a subscriber's proximity to a store). Preferably, the location of the subscriber is tracked using GPS (Global Positioning System), for example, by means of a GPS receiver in his/her personal electronic device. This personal grade is compared to rebate parameters defined by a particular business for a particular marketing campaign or targeted desired demographic in order to determine whether any rebate will be offered to that subscriber.

Using this system and method, a personal subscriber to the system, hereinafter “a subscriber” receives a personal rebate from the public price of a product or a number of products at a store or website belonging to a business subscriber, hereinafter: “a business”. The personal rebate can be offered or displayed to the subscriber as a rebate percentage that will be deducted from the price paid by the general public (e.g., 10% off), or as a personal discounted price (e.g., the amount to be paid after deducting the rebate). In the case of a rebate percentage, the subscriber will pay the full public price (say $10) and receive an immediate deposit of the rebate ($1) in his or her system account in the form of system credit, according to the offered rebate percentage of 10%. System credit can be used to pay for later transactions, or it can be withdrawn from the system account by the subscriber, e.g., as cash. If the subscriber prefers merely to pay the discounted price, instead of paying the full public price, the personal rebate percentage will be deducted immediately from the payment and no system credit will accrue.

According to some embodiments, the geographic, transactional and/or social data personal rebate is calculated according to a weighted ratio of the subscriber's geographic, transactional and/or social data to the geographic, transactional and/or social data of an average subscriber or an average of all subscribers.

The invention also permits a business to offer at least two different rebate options to its customers who are subscribers—a regular personal rebate or a personal posting rebate. The subscriber selects one of these options at the time of the transaction. The regular personal rebate is offered to the subscriber according to his purchasing history, social network details, etc., but without the need to publish any information regarding the current transaction. The personal posting rebate is a higher personal rebate offered in exchange for the subscriber publishing or posting information on a social network regarding the current business or transaction.

According to some embodiments, the system also includes a matching mechanism. The matching mechanism includes a software algorithm to match a subscriber to a business and calculate or quantify the quality of that match, i.e., how valuable a particular subscriber is to that business. The matching mechanism calculates a matching score based on the subscriber's personal information and the business' rebate parameters. According to some embodiments, this automatic matching mechanism determines whether or not the business will offer a personal rebate to the subscriber. This will only happen if the matching score is above a predefined threshold.

In another embodiment of the invention, if the calculated matching score is above a second, higher threshold, the subscriber will be flagged as an “important customer” or “VIP” by the system for that particular business or category of businesses/item. In this case, the system tracks the subscriber's GPS location and, when the subscriber physically enters that business's place of business (restaurant or store/shop) the system will send a message or other notification to the business announcing that an important customer or VIP is present. Alternatively, the system can track the subscriber's browsing history and when the subscriber is browsing that business's website, the system will send the business a message that an important customer or VIP is online in the site. This message or notification allows the business to give preferential treatment to the subscriber who is viewed as an important customer, even prior to the subscriber reaching the checkout.

According to further embodiments of the invention, the system includes identification units, which may be, for example, an RFID (Radio-frequency identification) tag, Bluetooth, or a barcode, which are placed on different products or at the entrance to places of business. These identification units can transmit to and/or be scanned by an electronic device of the subscriber in order to provide the subscriber with his/her personal rebate for that particular product or business. In this case, a different personal rebate can be offered for different products (e.g., cornflakes, detergent, cookies) and not merely a single, overall rebate for all products of a business (e.g., a restaurant or cafe). This allows the subscriber to receive a variety of personal rebates on different items within a single business.

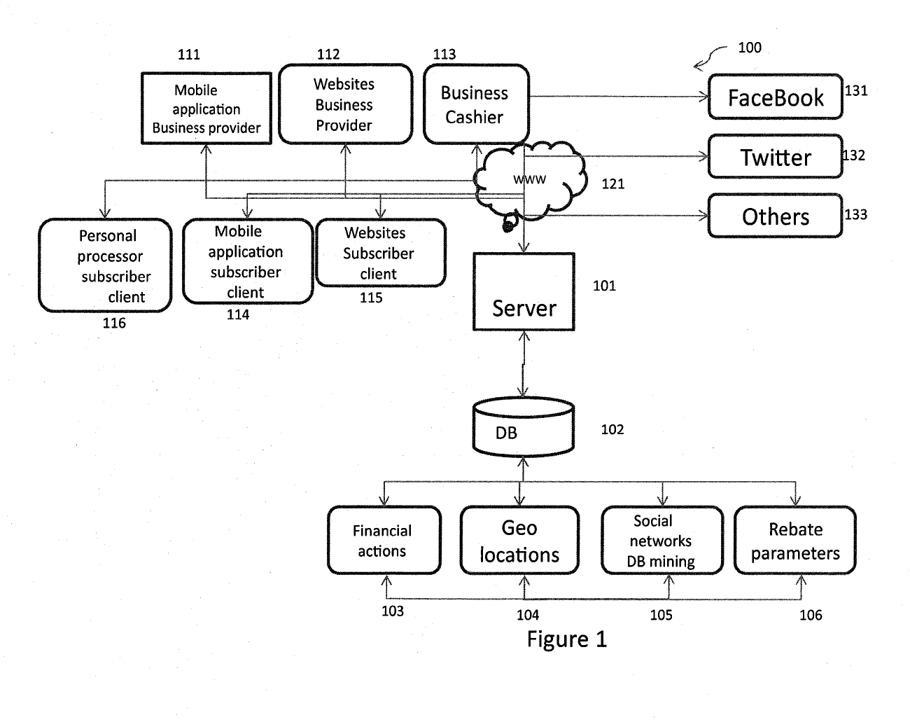

A block diagram illustration of a rebate system according to one embodiment of the invention is shown in FIG. 1. The rebate system 100 includes a rebate server 101 which has access to a system database 102. The registers (not shown) in the database 102 can store and access information and data that pertains to subscribers, such as financial history 103, current or recurring geographic locations 104, and information 105 mined by the rebate system 100 from the databases of social networks and social media 131-133. The database 102 can also store and access data that businesses provide regarding their rebate parameters 106 (including, for example, targeted demographics, and budget and/or rebate range based on particular marketing campaigns). The rebate server 101 can be accessed through the Internet 121 by businesses and subscribers using Mobile applications 111, 114, a subscriber's processing device 116 (personal computer, tablet, Personal Digital Assistant [PDA], or the like), websites 112, 115, or POS (point of sale) terminals 113, such as cash registers, business cashiers or other payment terminals which may have their own POS servers (not shown). The rebate server 101, as well as the businesses and subscribers (111-116), are also connected to one or more social media (e.g., Facebook® 131, Twitter® 132, or other 133) through the Internet 121.

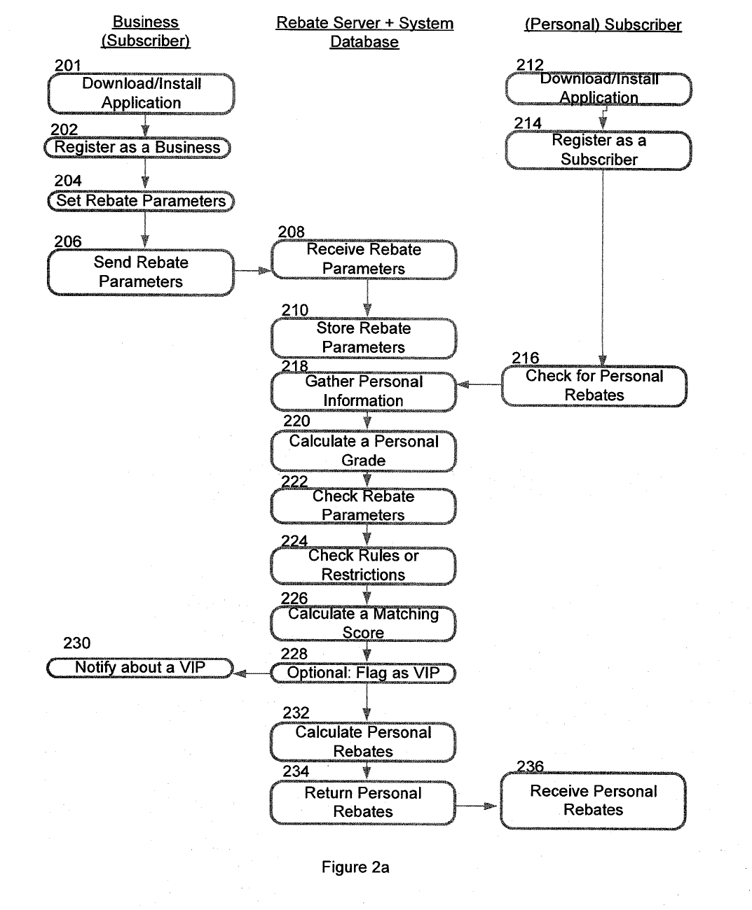

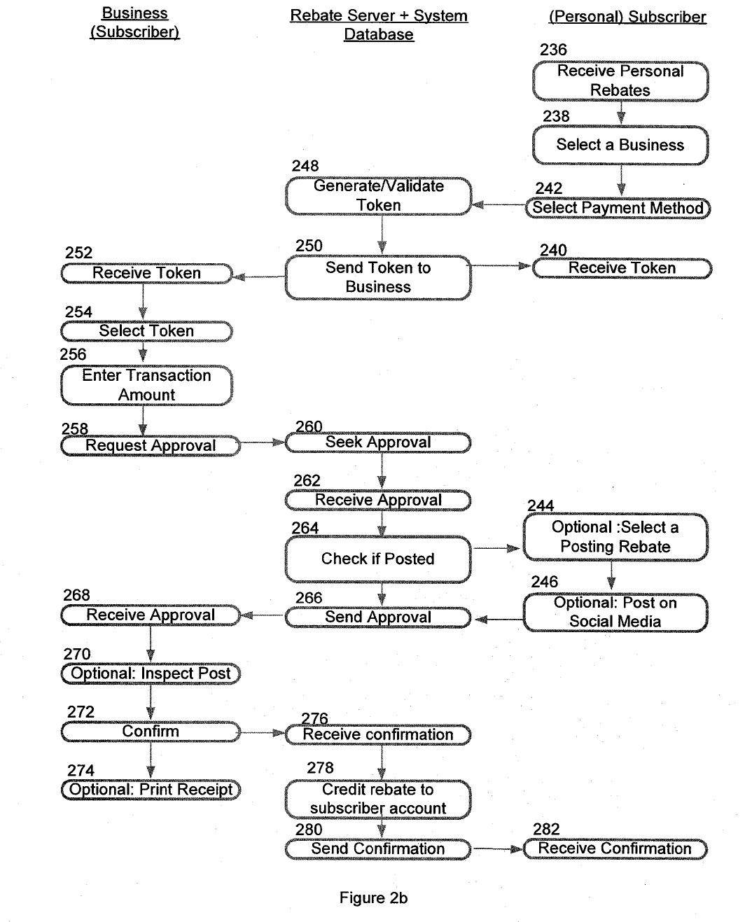

FIG. 2 is a flow chart of a method 200 for providing a rebate, according to one embodiment of the invention. A business downloads and installs a computer application for business subscribers (block 201), typically through the Internet, onto its processing device, typically a mobile device or POS terminal. This application is specially programmed and designed for businesses to access and provide two way communication with the rebate server. The business then registers (block 202) as a business subscriber using the installed application and sets its rebate parameters (block 204).

Rebate parameters may include the targeted demographics (e.g., age, gender, location) and minimum and maximum offered rebates (e.g., from 2% off up to 20% off a public price for a product or service). The rebate parameters are based on the business's marketing campaign and advertising strategy. This strategy may include preferred customer definitions for this particular campaign, e.g., returning customers, potential new customers, customers who live or travel nearby, etc. These rebate parameters will define which categories of the subscriber's personal information (e.g., popularity, places and prior transactions/purchase history) are most important to that business' marketing campaign. For example, purchasing history in that business is important when targeting returning customers, popularity on social media or purchasing history in similar stores or for similar products is important when targeting new customers, and geography is important when targeting for local customers or subscribers in the area of the business. The business's marketing campaign budget can also be a factor when determining the rebate parameters (e.g., how many rebates, and their values, will be offered). The rebate parameters can also include rules or restrictions for offering and/or receiving rebates (e.g., chronological restrictions, such as date or hour, and/or geographic restrictions, for example, based on the subscriber's current physical location within a particular city or state, frequented locations, home address, and/or IP address). For example:
1. The subscriber must be within the continent.
2. The subscriber must be within the country.
3. The subscriber must be close enough geographically to the business (e.g., below a certain threshold distance).
4. The transaction must take place during or before a certain time of day (hour) or date.

The business sends these rebate parameters to the rebate server (block 206). The rebate server receives this data (block 208) and stores it in registers in the system database (block 210). Alternatively, the business can send a general marketing strategy to the system and the system can use algorithms to parse that strategy and automatically set one or more of the rebate parameters in the database based thereon.

In parallel, a personal subscriber downloads and installs a computer application for personal subscribers (block 212), typically through the Internet and onto his/her processing device, typically a mobile device (e.g., smart-phone, tablet, PDA, etc.), although a personal computer or other non-mobile device can also be utilized. This application is programmed and designed for two way communication between the subscriber's processing device and the rebate server. The subscriber then registers (block 214) as a personal subscriber and provides personal information and, preferably, grants permission to take personal information from the subscriber's social media networks. This information is stored in the database for later access by the rebate server. The subscriber may now begin to search for available personal rebates (block 216).

A processor in the rebate server gathers additional personal information or data pertaining to the subscriber that is stored in databases belonging to social networks (e.g., Facebook®, Twitter®, or others) and/or the system database (block 218). This information may include data regarding past financial transactions in the system, geographic locations frequented by the subscriber, and information regarding the subscriber's social connections (popularity) mined from databases belonging to social networks. This information about the subscriber can be sorted or organized into several different categories.

When the subscriber enters the system and searches for a particular good or service, an algorithm running in the rebate server calculates a personal grade for that subscriber (block 220) using the subscriber's data collected above. This personal grade may be an overall personal grade and/or may include several personal grades for different specific categories: popularity, places, prior transactions/purchase history. Next, the rebate server reviews the rebate parameters stored in the rebate system database (block 222), as well as any rules or restrictions included in the rebate parameters set by the business or system (block 224), and calculates a matching score between the subscriber and the business (block 226). For example, whether the subscriber's location (determined by GPS) and the location of the business are close enough geographically, i.e., below a preset threshold, for the system to offer the subscriber a personal rebate. The rebate server calculates the matching score based on the subscriber's personal grade or grades and the business's rebate parameters. The number and value of transactions and/or visits to a particular business subscriber can also raise his matching score with that business. The number and value of transactions for similar items and/or visits to a competitor of the business subscriber may also affect his matching score with that business.

If the matching score is high (above a predefined threshold), the server can flag a subscriber who has a high matching score with the business as an “important customer” or “VIP” (block 228). VIP subscribers can be given preferential treatment, in terms of service and/or in terms of the rebates that are offered, i.e., they may receive a regular personal rebate and a personal posting rebate that are higher than those given to subscribers having fewer transactions or connections (lower matching score). Preferably, the rebate server notifies the business of a prospective important customer who has been flagged by the system as an “important customer” or “VIP” (block 230). Alternatively, the server can send a message to the business when the subscriber enters a certain proximity to the business.

The rebate server then calculates (block 232) and sends (block 234) a regular personal rebate and possibly a personal posting rebate for that business or item to the subscriber's processing device. Preferably, the rebate notification includes an indication of the expiration date or time of those particular personal rebates and any other rules or restrictions associated with them, e.g., geographical limitations for that rebate, in store or on-line, etc.

The subscriber receives a list of available personal rebates (block 236). If the subscriber sees a personal rebate that he/she finds attractive, the subscriber will enter that business (block 238) or begin that purchase transaction. When it is time for a subscriber to check out and pay for the transaction, the subscriber selects his/her desired method of payment (block 242). In accordance with that selection, the rebate server generates a token for that transaction indicating the rebate options the subscriber can use (block 248). The token indicates the identity of the subscriber, the payment method, and the personal rebates, which is valid for a limited period of time. The subscriber is preferably provided an indication of the time limit imposed on the token (e.g., an expiration date/time and/or a type of count-down timer until its expiration). The token is sent both to the subscriber and to the POS terminal of the appropriate business (blocks 250, 240). The subscriber may continue shopping before going to the check out. At the same time, the business may receive several tokens for different subscribers.

When the business receives the indication of payment method (block 252), it selects the appropriate token (i.e., for that transaction with that subscriber) and confirms the payment method and the rebate offered to the subscriber (block 254). If desired, an additional rebate can be offered for different payment types.

The business enters the amount of the transaction (block 256) and requests approval of the transaction (block 258) from the rebate server. The rebate server confirms approval of the transaction (block 262) (e.g., that the is rebate still valid, there is enough system credit in the subscriber's account, is it a valid credit card and will the sum be accepted by the credit card company). The rebate server notifies the business when approval is received (block 266) The subscriber then chooses his desired rebate percentage (block 244). If he chooses the regular rebate, the payment is completed and the subscriber receives a digital receipt and, if desired, a paper receipt. If the subscriber chooses the posting rebate, he will post, on the spot, a posting on one or more of his social media (block 246), either indicating the purchase or transaction just completed or providing a recommendation of the business.

The business checks (block 270) if the subscriber posted on his/her social media. The subscriber then pays the business for the transaction using the chosen payment method and the transaction is completed. The business confirms the transaction (block 272) and, optionally, prints out a paper receipt with the rebate amount written on it (block 274).

The business can now inspect the content of the subscriber's posting (block 270) to ensure that it is, indeed, positive. If the posting is not complimentary, the business has a limited period of time in which it can cancel the transaction and invalidate the rebate. If a business chooses to cancel a rebate, the subscriber will not be credited with the rebate for that transaction or, if he/she was already credited, the subscriber's account will be debited the amount of the rebate.

Once the system server receives confirmation from the business (block 276), it credits the subscriber's system account with the rebate amount (block 278) and sends a confirmation to the subscriber (block 280). As soon as the subscriber receives the receipt (block 282), he or she can immediately use that system credit to pay for a next transaction or can withdraw it as cash.

### EXAMPLE

The method of calculating the personal rebate according to one embodiment of the invention is as follows. First, each business owner fixes the maximum rebate he is willing to give in his business, or for a particular campaign, e.g., 10%. These percentages can be changed at any time and all the customers will be affected accordingly.

The system takes this total rebate percentage and divides it into 3 parts, not necessarily equal—e.g., 33% to each, or 50%, 25%, 25%—according to the business owner's preference. The first part of the overall rebate is calculated based on a ratio of the number of different geographic locations to which the subscriber traveled and number of times he or she entered the system in the previous 30 days (not calendar month). The second part of the overall rebate is set according to the number of purchases made through the system by the subscriber in the past 30 days. The system will compute the average number of transactions by all subscribers in the area of that subscriber relative to the number of transactions of the subscriber, himself, in that time, and will calculate the ratio.

The last portion will be set according to the subscriber's popularity or social activity relative to the other subscribers in his geographic location, calculated at the time of entry into the system. This portion is further divided to 4 parts—1) the number of friends the subscriber has, calculated per each network, if he belongs to several networks (i.e., friends or followers the subscriber has on his personal channel (such as Twitter® feed, or Facebook® page), 2) how often the subscriber created or updated content in his social media—for example, how many Facebook® status updates he posted over the past 30 days and how much feedback his content or updates receive. For the present example, the number of posts that the subscriber made in the past 30 days, multiplied by the number of Likes he received on his posts, multiplied by the number of comments to his posts, multiplied by the number of Shares, 3) the number of times the subscriber checked into his networks in the past 30 days, 4) the number of words times the number of pictures he posted on his Facebook® Wall, all relative to the other subscribers in his area. It will be appreciated that these parameters provide an indication of the level to which the subscriber is influenced by others in the area and the level to which he or she can influence others in that area, at any given time.

These three categories of parameters are used to calculate a weighted average which will be used to calculate the relative percentage of the maximum rebate the business is willing to give that will be offered to that subscriber.

For example, say the business has decided on a maximum rebate of 10% and wishes to divide the weighting of each element equally, i.e., 33% to each. Suppose subscriber X enters the rebate system now. The first third or component of his overall rebate is divided in two, one based on geographic locations and the other on entries into the system. First, the server will calculate the geographic component of the rebate percentage. It will calculate the average number of locations for all subscribers in the past 30 days, say 100 locations. If subscriber X visited 50 locations in the past 30 days, his partial score will be 50% of ½ of the 33%. Looking now at the number of entries into the system over the past 30 days, the server finds the average subscriber entered 800 times. If subscriber X entered 260 times, his partial score will be 30% of ½ the 33%. So for the first part, subscriber X will be entitled to 8.25%+5.5%, or 13.75% of the 33%=4.54%.

The second third of the rebate value is based on the number of transactions by the subscriber in the system. The server calculates the average number of transactions of all subscribers over the past 30 days, for example, 30 transactions (1 per day). Subscriber X closed 15 transactions. So subscriber X's transaction score is 50% of the available 33% or 16.5%.

Typically in the system, subscriber X's regular rebate will be calculated from these two figures=4.54%+16.5%=21% of the maximum rebate of 10%, or 2.1% regular rebate.

In order to calculate the posting rebate, the third category of parameters enters the calculation. This category relates to the subscriber's popularity or social activity, as described above. The subscriber is comparable to a poster or billboard, and is graded according to the number of people who are likely to see him. In this way, a subscriber will receive the personal rebate which fits his/her particular contribution or value as a poster or advertisement and also the business benefits from low cost advertising. Thus, the final 33% of the total rebate score is divided into 4 portions—friends, posts, check-ins, and photos. The weight of these parameters, too, can be divided equally, i.e., 8.25% for each parameter, or unequally, if the business or server view one or more categories as being more valuable to the business. Thus, for example, the division can be 5.5% for number of friends, 16.5% for number of posts and responses, 5.5% for check-ins and 5.5% for words and pictures.

To continue the example, assuming an equal division among the social activity categories, the server will calculate the number of friends an average subscriber has on a social network. Suppose the average is 150 friends and subscriber X has 50 friends. Subscriber X would receive ⅓ of the 8.25% of the available rebate. Regarding posts and likes, if the average number per subscriber is 10 likes and 20 comments and subscriber X received 30 Likes and 20 comments, then subscriber X will receive the entire 8.25% for this category. If the average number of check-ins to one's social network was 10 and Subscriber X entered 5 times, he will receive ½ of the 8.25%. Finally, suppose subscriber X has one quarter of the average number of words and pictures. Summing up the four social activity parameters, subscriber X received 2.75%+8.25%+4.125%+2.06%, or a total for all four of 17.18% of the final 33% or 5.67%. Combined with the first two partial rebate scores, subscriber X will receive 26.67% of the maximum offered by the business—2.67% as a posting rebate.

According to the embodiment described above, there are three main categories of a subscriber's personal information taken into account when calculating a subscriber's personal rebates: social activity, prior transactions or purchasing history, and geographical location. It will be appreciated that any other parameters can be used alternatively or in addition in calculating the personal rebates. For example, alternate geographic data can include the geographic location of the subscriber's home or work place or the geographic locations of other establishments where the subscriber often purchases. The selected parameters and percentages for various marketing campaigns can be selected in view of public surveys, surveys of purchasers, from statistics of prior purchases, collecting data and performing statistical analyses, as known, or in any other fashion. If desired, the formula for calculating the rebates can be a product of a selected economic model.

While the invention has been described above with regard to certain parameters which are felt, to be particularly applicable to a subscriber's potential value to a business, alternatively, any other or additional characteristics or parameters about the subscriber can be used in calculating a personal rebate for that subscriber.

It will be appreciated that these data are constantly changing. Therefore, a subscriber's grades and matching scores will also change each time he or she enters the system. Accordingly, a subscriber's grade will be calculated only when the subscriber looks for transactions in the system or when the subscriber's previous data fall within the rebate parameters set by the business.

Preferably, the personal rebate that the business offers will be calculated within minimum and maximum rebate parameters (including available rebate values) set by that business. Alternatively, or in addition, the minimum can be set according to internal rebate system classifications, for example for restaurants and cafes the minimum can be 7%, while the maximum is set by each individual business. The personal rebate offered to a subscriber will be between the minimum possible rebate value and the maximum set by the business.

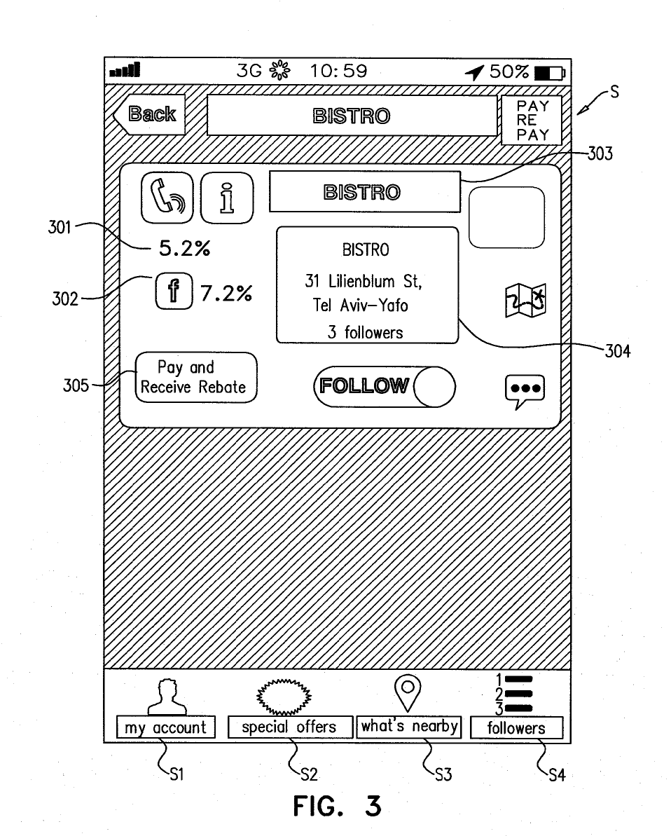

One exemplary method of operation will now be explained with reference to FIGS. 3 to 12.

FIGS. 3-6 and 12 are screen views of a subscriber's mobile device S running a rebate system application for a mobile device, in accordance with one embodiment of the present invention, which illustrate various screens that appear on the subscriber's device. The screen views on the subscriber's device S include links to the subscriber's account s1, special offers s2, what's nearby s3 and followers of the subscriber s4.

The subscriber first uses his device S to determine what businesses in the area are offering personal rebates. The businesses, or a specific item at the business, can have an identification unit (not shown), e.g., an RFID tag, that transmits information to the subscriber indicating that a personal rebate is available. Alternatively, the appropriate businesses are selected by the rebate system according to their current advertising campaigns. A selection screen (not shown) can display a plurality of different businesses or items, typically in the geographical area, offering personal rebates that the subscriber can choose from.

The subscriber then selects one of those businesses (or items). This selection is sent to the rebate server which calculates two personal rebates for this individual subscriber—a regular personal rebate and a personal posting rebate—based on his/her personal grade(s), the rebate parameters and a matching score between the subscriber and the business. The posting rebate is applicable in the event that the subscriber agrees to post on one or more social networks the fact that he is currently engaged in a transaction with that business. In some embodiments, the calculation of the available personal rebates is automatic (even without the subscriber first selecting a business) and the rebates are displayed alongside the different available businesses. If the matching score is high (above a certain threshold), a notification message can be sent to the business's payment terminal and/or the business manager's mobile device to notify them that the subscriber has a high match with the current business. (Alternatively, this message can be sent when the subscriber enters a certain proximity to the business.). This allows the business to provide the subscriber with preferential treatment (e.g. better service, added in-store bonuses, etc.). The subscriber is notified of the available personal rebates as well as its expiration date and/or any other restrictions associated with those rebates.

The screen shown in FIG. 3 includes a field 303 for the name of the business (e.g. Bistro) and a field 304 setting forth its address or location. The available personal rebates, regular personal rebate 301 and posting rebate 302, are also displayed on the subscriber's mobile device S, e.g., on a personalized rebate screen as shown in FIG. 3, as well as on the POS terminal or other cashier device of the business. Regular personal rebate 301 represents the rebate which the business is willing to offer the subscriber (in this example, 5.2% off) due to his or her grade and matching score. Posting rebate 302 represents the rebate that the business is willing to offer if the subscriber agrees to publicize or advertise his purchase using social media (e.g., Facebook®, Twitter®, etc.) (in this example, 7.2% off). It will be appreciated that, for the same business or item, different subscribers will receive different personal rebates based on their own personal grades and/or matching scores. The personal posting rebate is generally higher than the regular personal rebate, which provides the subscriber motivation to publicize the transaction and, thus, provide advertising for the business.

Once the subscriber has collected all his purchases and arrived at the cashier/POS terminal, he can select a link 305 to pay and receive a rebate.

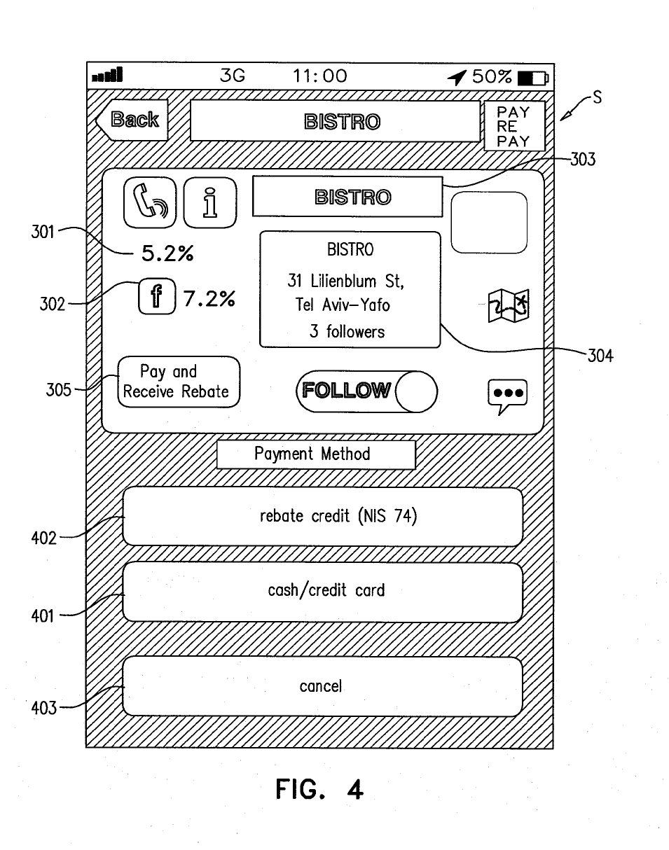

The subscriber is then directed to a payment method selection screen, as shown in FIG. 4, to select his desired method of payment. The subscriber can pay by means of a credit card or cash 401 or by means of credit accrued by the subscriber in his or her account in the system 402, i.e. rebate credit or “system credit”. If the subscriber is undecided, and would like to return to the previous screen, he can also choose to cancel the selection 403 for the time being and then make his selection at a later time.

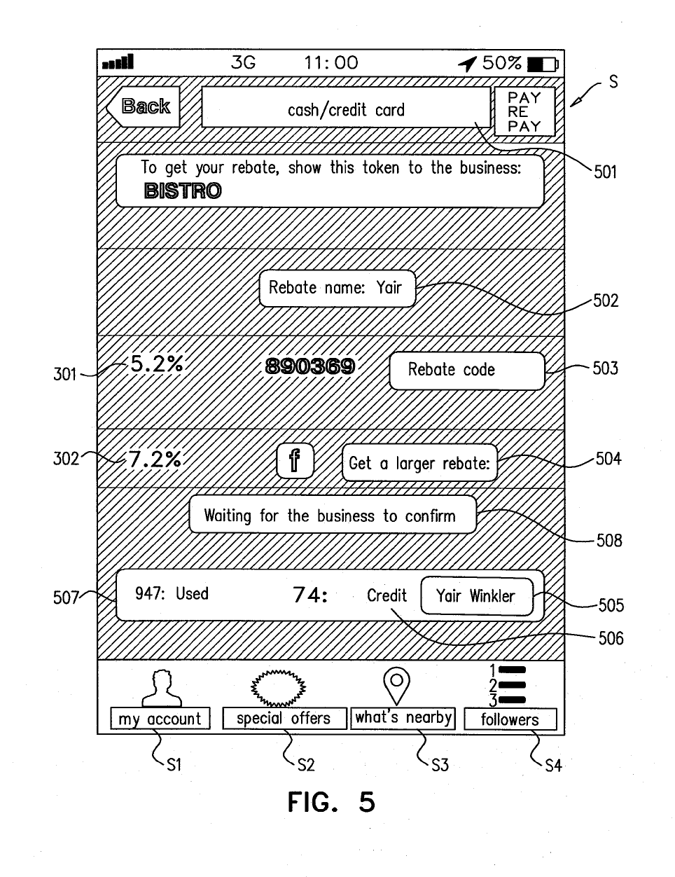

Once the subscriber selects the payment method, a token 500, as shown in FIG. 5, appears on his screen. Token 500 includes a transaction code 503 (or “rebate code”) and a rebate name 502 (the name of the subscriber). Token 500 is generated by the rebate server. The rebate code 503 is an indication of the conditions of the transaction. The token also may include an indication of the personal (regular 301 and posting 302) rebates of the subscriber. This token is valid only for a pre-set, limited amount of time, to prevent fraud. The rebate system validates the token, i.e., determines that the token is still in force, that the payment method is valid and that the rebates are still appropriate, based on a set of rules associated with the business and/or with that transaction. If the rules are satisfied, the rebate server sends the token to the business (POS terminal). The subscriber and the business are preferably provided an indication (not shown) of the expiration date of the token and any other restrictions that accompany the token. After selecting a payment method and receiving the token, the subscriber is directed to a rebate selection screen, as shown in FIG. 5, and now waits for confirmation of the payment method from the business. While the subscriber is waiting he/she can use the rebate selection screen to select the higher personal posting rebate post.

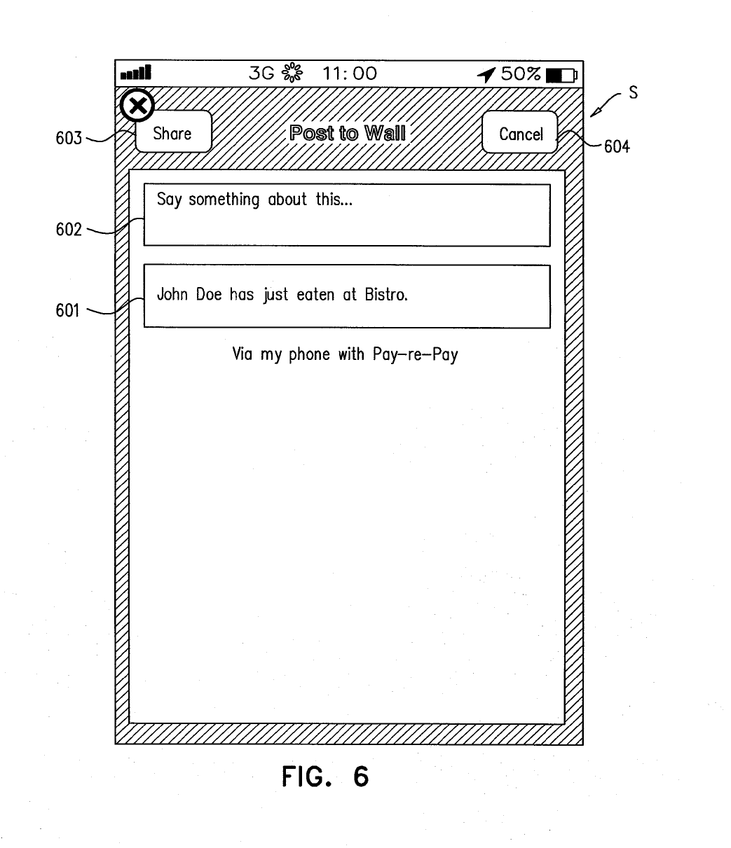

The rebate selection screen shown in FIG. 5 allows a subscriber to choose between the regular personal rebate 301 or the personal posting rebate 302. An indication 501 of the selected payment method is also displayed. The subscriber's (account) name 505, available system credit 506, and used system credit 507 can also be displayed, as well as an indication 508 that the subscriber is waiting for the business to confirm the transaction. While the subscriber is waiting, he/she can choose to post about the transaction on his/her social media/network and receive the higher personal posting rebate (select the higher personal posting rebate). The screen in FIG. 5 includes a link 504 for selecting the personal posting rebate 302. If he/she selects the link 504 for the personal posting rebate 302, the subscriber's mobile device S will be directed to the subscriber's social network wall, as shown in FIG. 6, for the subscriber to input his/her post. A standard message 601 may be provided, as well as a field 602 for the subscriber to input a personalized comment. The subscriber can then decide to either share his/her post by clicking on link 603 or opt out of posting (and the personal posting rebate) by selecting on the cancel link 604.

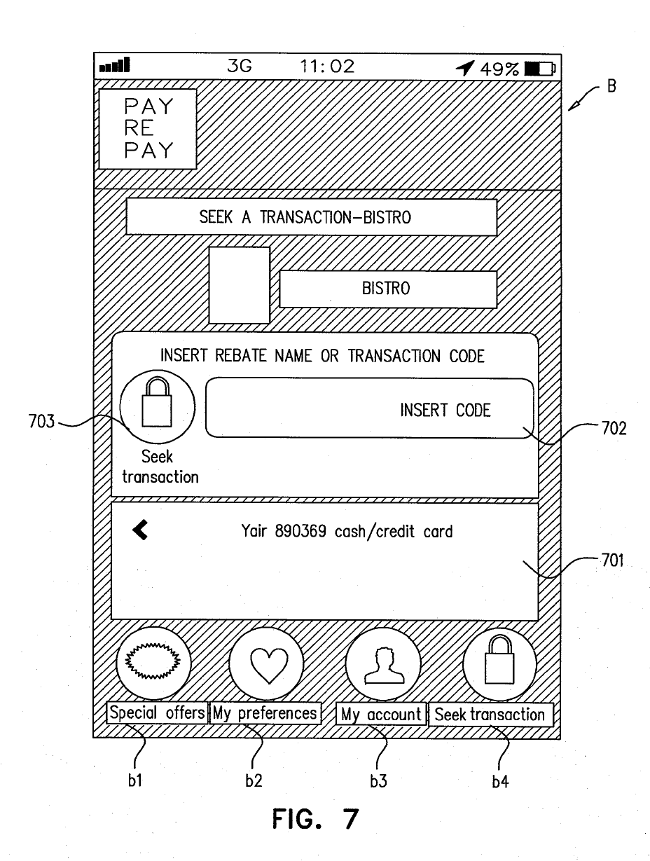

FIGS. 7-11 are screen views of the business's POS terminal B running a rebate system application for a POS terminal having means for two-way communication between the terminal and the rebate server, in accordance with one embodiment of the present invention, which illustrate various screens that appear on the POS terminal (or other device) of the business. Alternatively, these screens can be run from the payment terminal's main window using the terminal's API (Application Programming Interface), a website window running from a PC or mobile or even a native application, e.g., iPhone® or Android. The screen views on the business's POS terminal B include links to special offers b1, preferences b2, the business's account b3, and a link to seek transactions b4, for example by token, rebate name or rebate code.

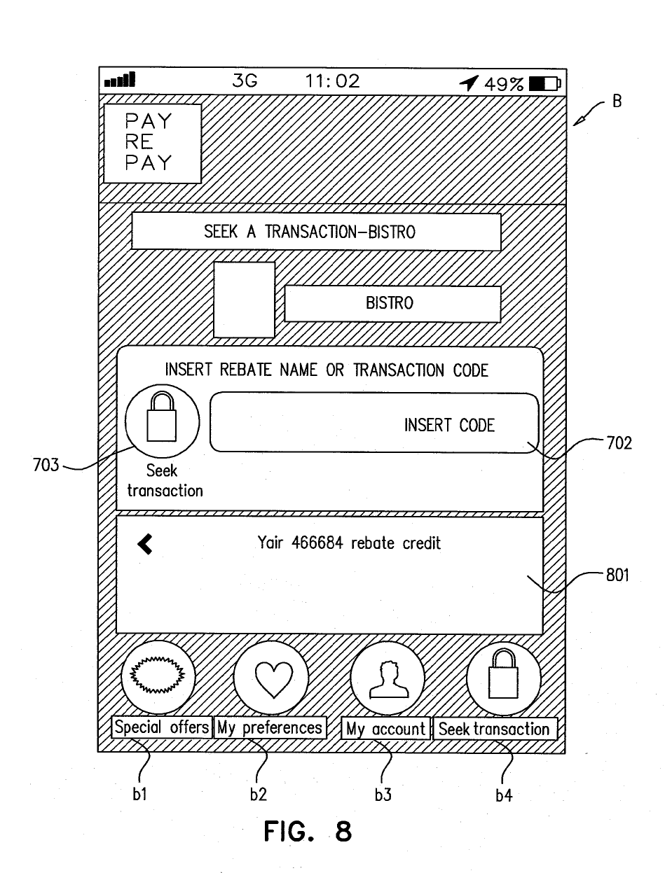

FIGS. 7 and 8 are examples of a transaction selection screen on the business's POS terminal B used to find and select tokens that have been generated for a plurality of subscribers. A button 703 is provided for executing that search. After a specific token has been sent to the business, the business goes to the screen for selecting and approving transactions to see the token. The token illustrated will depend on the payment method selected by the subscriber, e.g. FIG. 7 (payment by credit card or cash) or FIG. 8 (payment with system credit). According to some embodiments, the transaction selection screen can display a plurality of tokens, each of which represents a different transaction currently awaiting approval. When the subscriber is paying with credit or cash, the token may look, for example, like the cash token 701, shown in FIG. 7. When paying with accrued system credit in the subscriber's rebate account, the token may look, for example, like the credit token 801, shown in FIG. 8. The subscriber's code can be input at field 702 to be searched for by the business POS terminal B.

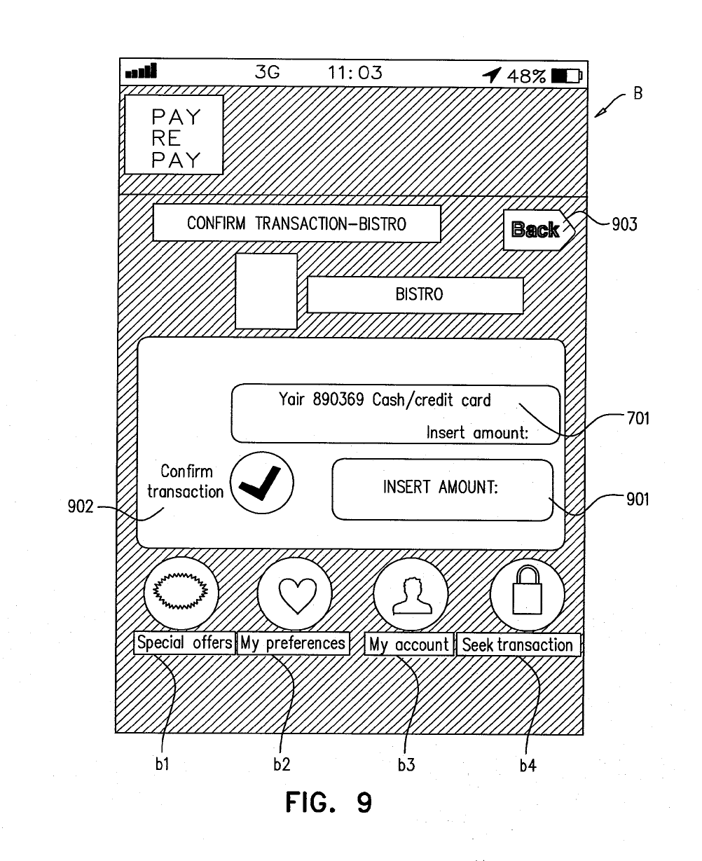

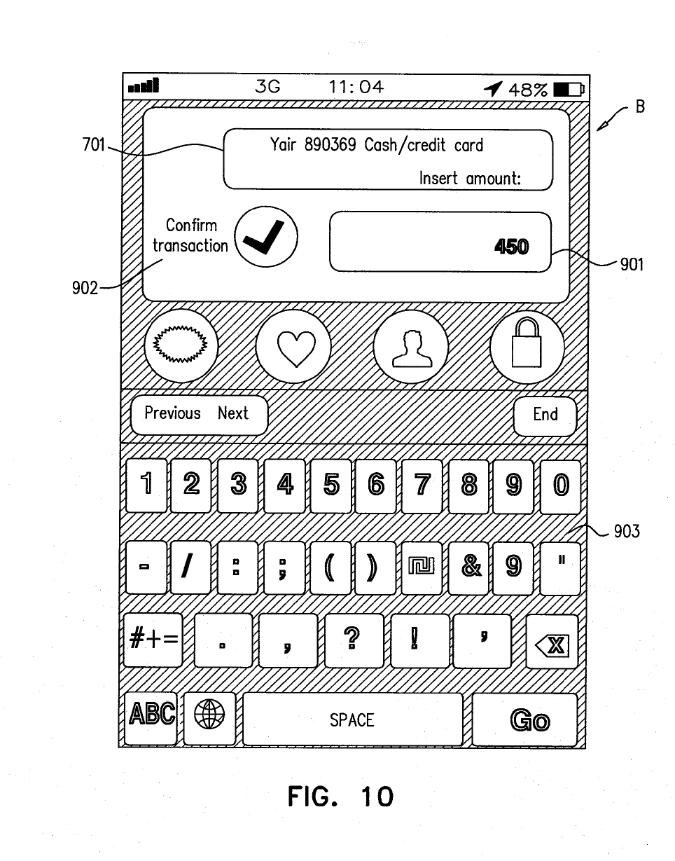

After the business has found and selected the desired token, it is directed to a screen for entering the amount of the transaction, as shown in FIG. 9. Pressing insert amount field 901 will cause a window, shown in FIG. 10, to open. Here, a keyboard 903 is provided for typing in the amount of the transaction. The amount is confirmed by means of a button 902. The business enters the amount of the transaction (for example $450), and then requests (waits for) approval from the system (rebate server).

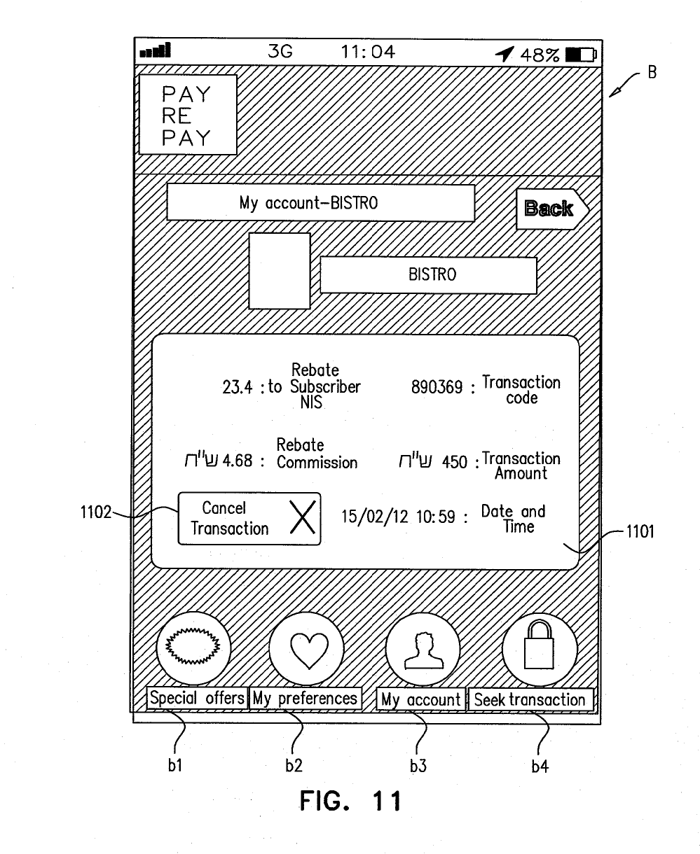

In case of payment by credit card, the system server or business POS terminal B seeks approval from the credit card company or the terminal's API and redirects the business POS terminal B to the transaction confirmation screen, as seen in FIG. 11. In the case of payment by system credit, the system server checks the system database if the subscriber has enough credit for the present transaction. If there is not, the system server replies that there is insufficient credit and rejects the transaction. If there is, it approves the transaction. In the case of cash, the system need not wait for approval. The system server can now check if a subscriber chose to post and receive the personal posting rebate. The business can check the content of the subscriber's post to ensure that the posting meets with the approval of the business.

When the transaction has been completed, the details of the transaction, including data and time, transaction code and transaction amount 1101, together with the rebate rate and commission, which are displayed at the business POS terminal B, for example, as shown in transaction confirmation screen FIG. 11 will be send to the rebate server. The business now has a certain period of time, e.g., 10 minutes, to either confirm or cancel the transaction. The default can be that at the end of the time period (if the time period expires) the transaction is confirmed. During that time period the business can check the posting of the subscriber and click on a link 1102 to cancel the transaction. For example, if the subscriber wrote insulting comments in his social media post, or for any other justifiable reason, the business can click on link 1102 and cancel the transaction. According to certain embodiments, under these circumstances, the system will be able to remove the offending post and/or the system will cancel the rebate.

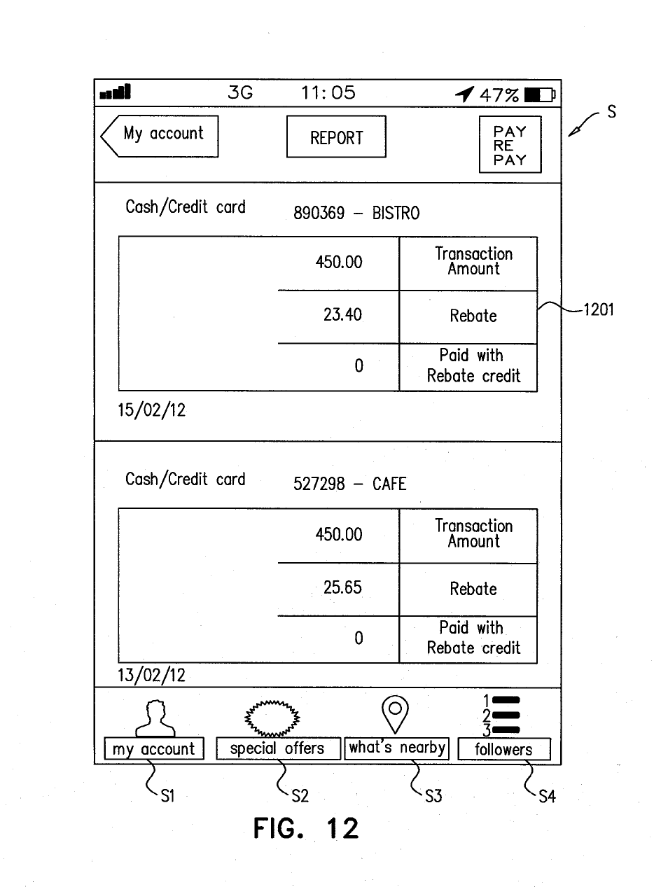

If the business confirms the transaction, the subscriber receives a digital receipt 1201, as shown in transaction receipt screen FIG. 12, and the rebate is automatically deposited in his/her account in the rebate system, regardless of the method of payment by the subscriber, even if he or she paid by cash. This amount is added to the subscriber's accrued system credit due to rebates received or by payments to the system. The accrued system credit can be used to “pay” for later transactions, given as a gift to another subscriber, can be withdrawn as cash for any other use, or can be treated in any other fashion as if the system were a bank. A “transaction confirmed” notification screen (not shown) appears on the business POS terminal B. If the transaction has been made via the terminal's API, a summary notification, e.g., “a rebate amount of $27 is returned to you”, will be printed on the subscriber's bill (not shown). Alternatively, the subscriber can pay a personal discount price and not receive credit.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A method of providing a rebate for a purchase, the method comprising:
collecting and storing, in a database of a rebate server, personal data and transaction history regarding a personal subscriber;
receiving rebate parameters from a business subscriber in a database of the rebate server;
calculating a personal rebate for a new transaction with said business subscriber based on said personal subscriber data and said rebate parameters for said personal subscriber; and
upon receipt of payment for said new transaction, providing said personal rebate to said personal subscriber.

2. The method according to claim 1, further comprising:
collecting social network activity data of said personal subscriber;
calculating a personal posting rebate for said new transaction, higher than said personal rebate, based on said collected personal, transaction history and social network activity data and said rebate parameters for said subscriber for posting information of said transaction on a social network; and
upon receipt of payment for said transaction, providing one of said regular personal rebate or said posting personal rebate to said subscriber.

3. The method according to claim 1, wherein said step of calculating includes:
receiving an overall rebate percentage from said business subscriber;
dividing said overall rebate percentage into at least one rebate portion;
calculating said at least one rebate portion of said overall rebate percentage based on a selected parameter of said subscriber; and
multiplying said rebate portion by said overall rebate percentage to determine said personal rebate.

4. The method according to claim 3, wherein:
said step of dividing includes dividing said overall rebate percentage into more than one rebate portions;
said step of calculating includes calculating each said rebate portion of said overall rebate percentage based on a selected parameter of said subscriber;
adding said rebate percentage portions for a total rebate percentage; and
multiplying said total rebate percentage by said overall rebate percentage to calculate the subscriber's personal rebate.

5. The method according to claim 3, wherein said parameters are selected from the group including subscriber transaction history, geography and social activity.

6. The method according to claim 1, further comprising receiving, from a personal subscriber, identification data received by said personal subscriber from an object or service provider, before said step of calculating.

7. The method according to claim 1, wherein said step of providing said rebate includes providing said rebate to an account of said subscriber.

8. The method according to claim 7, wherein the step of receipt of payment includes receipt of payment by any one of the group including: the personal subscriber's credit or debit card, a third party credit card, cash, and rebate credit in said subscriber account.

9. A system for payment by a subscriber having a personal processing device to a business subscriber having a business payment terminal, the system comprising:
a rebate server accessible via the Internet and coupled to at least one social media network;
a system database connected to said rebate server storing data of at least one personal subscriber and rebate parameters of at least one business subscriber;
personal subscriber communication means for two-way communication between said personal subscriber processing device and said rebate server;
a GPS system in said personal subscriber processing device;
business subscriber communications means for two-way communication between said business subscriber payment terminal and said rebate server; and
a processor in said rebate server configured to calculate a personal rebate for a new transaction with said business subscriber based on said personal subscriber data and said rebate parameters for said personal subscriber.

10. The method according to claim 2, wherein said step of calculating includes:
receiving an overall rebate percentage from said business subscriber;
dividing said overall rebate percentage into at least one rebate portion;
calculating said at least one rebate portion of said overall rebate percentage based on a selected parameter of said subscriber; and
multiplying said rebate portion by said overall rebate percentage to determine said personal rebate.

11. The method according to claim 2, further comprising receiving, from a personal subscriber, identification data received by said personal subscriber from an object or service provider, before said step of calculating.

12. The method according to claim 2, wherein said step of providing said rebate includes providing said rebate to an account of said subscriber.

13. The method according to claim 12, wherein the step of receipt of payment includes receipt of payment by any one of the group including: the personal subscriber's credit or debit card, a third party credit card, cash, and rebate credit in said subscriber account.
